(19) United States
(12) Patent Application Publication
(10) Pub. No.: US 2003/0121948 A1
(43) Pub. Date: Jul. 3, 2003

(54) Device for disabling shooting when nails runs out in a pneumatic nailer

(76) Inventor: Chen Ming Hsien, Taichung (TW)

Correspondence Address: CHARLES E. BAXLEY, ESQUIRE, Hart, Baxley, Daniels & Holton, 5 FI, 59 John St., New York, NY, 10038, US

(21) Appl. No.: 10/226,790

(22) Filed: Aug. 26, 2002

(30) Foreign Application Priority Data
Dec. 31, 2001 (TW) 090224554

(51) Int. Cl. B25C 1/16

(52) U.S. Cl. 227/120

(57) ABSTRACT

A magazine includes two passages defined therein and each passage has a spring, a pushing member and an end piece received therein. The spring biases the pushing member and each end piece has a resilient member received therein and a pin movably extends through two slots defined in two opposite walls of the end piece. The pin is fixed to the magazine and the resilient member is biased between an inside of the end piece and the pin. A pushing plate is movably connected to the two pushing members so as to push nails in the magazine toward the nose connected to the magazine. The end pieces protrude into the nose when the pushing members push the end pieces while no nail is located in the nose. The protrusion of the end pieces in the nose prevents the safety device from being pushed.

### FIELD OF THE INVENTION

The present invention relates to a pneumatic nailer which is not able to shoot when no nail is located in the ejecting nose of the nailer.

### BACKGROUND OF THE INVENTION

A conventional pneumatic nailer generally includes a trigger connected to the barrel of the nailer and a nose is connected to the barrel so that nails are ejected from the nose by pneumatic power. A magazine for storing nails is disengageably connected to the barrel and feeds the nails into the nose one by one. A safety device is located beneath the nose and one end of the safety device is located close to the trigger so that the trigger can only pulled when the safety device is pushed. However, the pulling of the trigger is independent from the feeding of the nails so that even if the nails run out, and if the user does not notice that, he or she properly pulls the trigger without knowing that no nails are ejected from the nose. This reduces the efficiency of the work.

The present invention intends to provide a device that makes the trigger cannot be pulled if no nail in the nose of the nailer.

### SUMMARY OF THE INVENTION

In accordance with one aspect of the present invention, there is provided a combination of a magazine and a nose connected to the magazine, wherein two passages are defined in the magazine and each of which has a spring and a pushing member received therein. An end piece is received in each passage and two slots are defined through two opposite walls of the end piece. A resilient member is received in the end piece and a pin movably extends through the two slots. Two holes are defined through two opposite walls of each of the passages and the pin is engaged with the two holes of the passage. The resilient member is biased between an inside of the first end of the end piece and the pin. A second end of the pushing member faces a first end of the end piece. A pushing plate is movably connected to the two pushing members and a leading edge of the pushing plate pushes nails in the magazine.

The nose is connected to the magazine and communicates with the two passages. A second end of the end piece protrudes into the nose when the second end of the pushing member pushes the first end of the end piece.

The primary object of the present invention is to provide a device that extends into the nose to prevent the safety device from being pushed when no nail is located in the nose.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the device for preventing the safety device from being pushed of the present invention;

FIG. 2 is a cross sectional view to show the pushing plate in the magazine pushes nails into the nose, and

FIG. 3 shows that second end of each of the end pieces extends into the nose.

### DETAILED DESCRIPTION OF THE PREFERRED EMBODIMENT

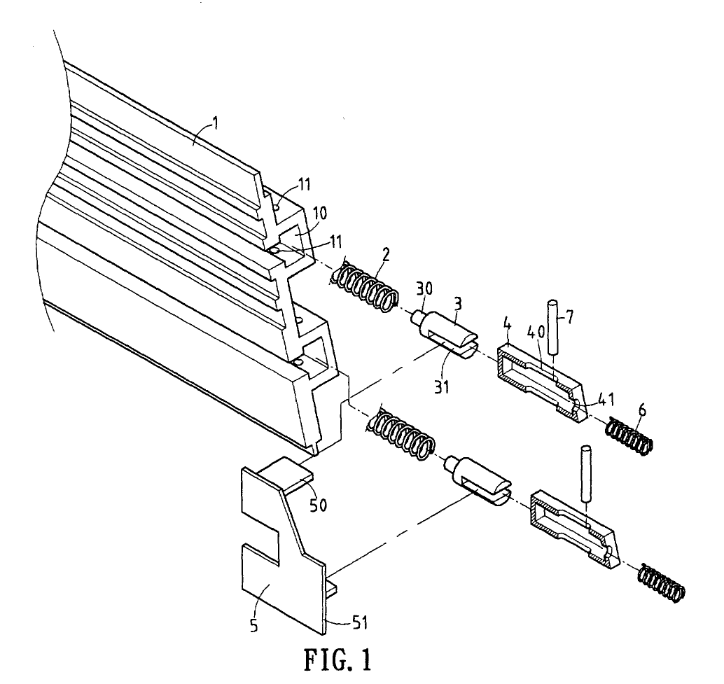

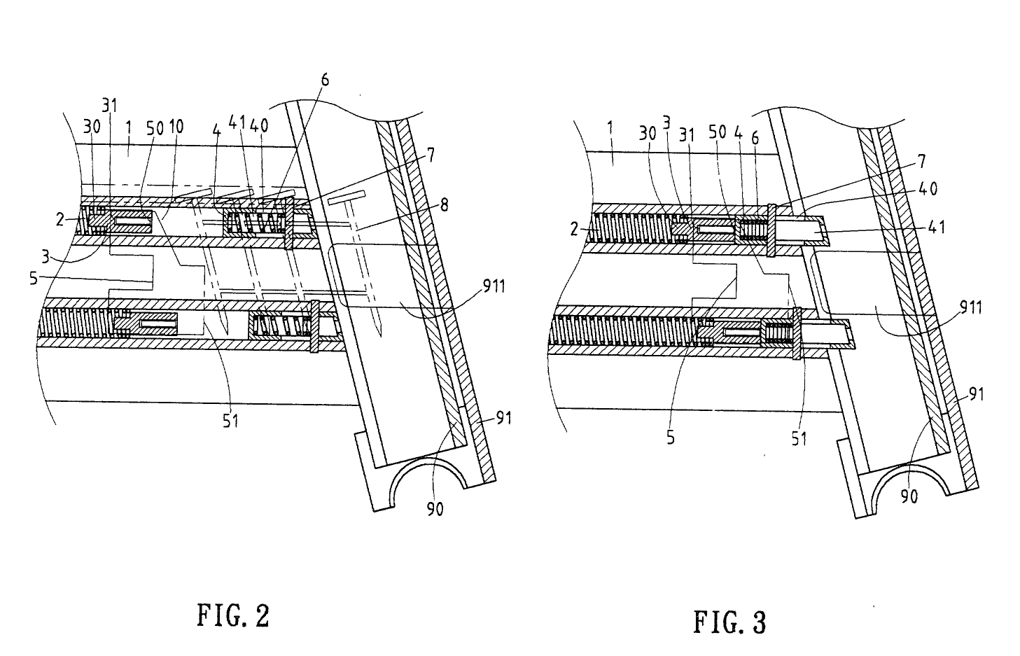

Referring to FIGS. 1 and 2, the magazine 1 of the pneumatic nailer of the present invention comprises two passages 10 and each of which has a spring 2, a pushing member 3 and an end piece 4 received therein. The spring 2 is biased between an inside of the passage 10 and a first end of the pushing member 3. A rod 30 extends from the first end of each of the two pushing members 3 so that the spring 2 can be well positioned. Each of the end pieces 4 has two slots 40 defined through two opposite walls thereof and a resilient member is received in the end piece 4. A pin 7 movably extends through the two slots and two ends of the pin 7 are engaged with two holes defined through two opposite walls of each of the passages 10. The resilient member 6 is biased between an inside of the first end of the end piece 4 and the pin 7. A second end of the pushing member 3 faces a first end of the end piece 4. The spring 2 has a larger biasing force than that of the resilient member 6.

A pushing plate 5 is movably connected to the two pushing members 3 and a leading edge 51 of the pushing plate 5 pushes nails 8 in the magazine 1 toward the nose 90 which is connected to the magazine 1 and in communication with the two passages 10. A safety device 91 is movably mounted to the nose 90 and a protrusion 911 movably extends in the nose 90. The protrusion 911 is located between the two passages 10 in the magazine 1. Each of the pushing members 3 has a slot 31 and the pushing plate 5 has two insertions 50 which are engaged with the two slots 31 of the two pushing members 3. The pushing plate 5 is pushed by the springs 2 to push the nails 8 into the nose 90 to be ejected.

As shown in FIG. 3, when the nails 8 are used out, because the spring 2 has a larger biasing force than that of the resilient member 6, so that the end pieces 4 are pushed toward the magazine 1 and the resilient member 6 are compressed. A second end of each of the end pieces 4 protrudes into the nose 90. The protrusion 911 of the safety device 90 is located between the two second ends of the end pieces 4 such that the safety device 90 cannot be moved and the trigger is therefore cannot be pulled.

The pneumatic nailer is not able to shoot when no nail is in the nose 90 and the user acknowledges that nails should be loaded again.

While we have shown and described the embodiment in accordance with the present invention, it should be clear to those skilled in the art that further embodiments may be made without departing from the scope of the present invention.

What is claimed is:

1. A combination of a magazine and a nose connected to the magazine, comprising:
two passages defined in the magazine, a spring and a pushing member received in each passage, the spring biased between an inside of the passage and a first end of the pushing member, an end piece received in each passage and two slots defined through two opposite walls of the end piece, a resilient member received in the end piece and a pin movably extending through the two slots, two holes defined through two opposite walls of each of the passages and the pin engaged with the two holes of the passage, the resilient member being biased between an inside of the first end of the end piece and the pin, a second end of the pushing member facing a first end of the end piece, a pushing plate movably connected to the two pushing members and a leading edge of the pushing plate adapted to push nails in the magazine, and
the nose connected to the magazine and communicating with the two passages, a safety device movably mounted to the nose and a protrusion movably extending in the nose, the protrusion located between the two passages in the magazine, a second end of the end piece protruding into the nose when the second end of the pushing member pushes the first end of the end piece.

2. The combination as claimed in claim 1, wherein each of the pushing members has a slot and the pushing plate has two insertions which are engaged with the two slots of the two pushing members.

3. The combination as claimed in claim 1, wherein a rod extending from the first end of each of the two pushing members.

4. The combination as claimed in claim 1, wherein the spring has a larger biasing force than that of the resilient member.
